(19) United States
(12) Patent Application Publication
(10) Pub. No.: US 2024/0070523 A1
(43) Pub. Date: Feb. 29, 2024

(54) MACHINE LEARNING TRAINING CONTENT DELIVERY

(71) Applicant: Microsoft Technology Licensing, LLC, Redmond, WA (US)

(72) Inventor: Allan Rafael CASCANTE VALVERDE, Heredia (CR)

(73) Assignee: Microsoft Technology Licensing, LLC, Redmond, WA (US)

(21) Appl. No.: 17/893,451

(22) Filed: Aug. 23, 2022

(51) Int. Cl. G06N 20/00

(52) U.S. Cl. CPC G06N 20/00

(57) ABSTRACT

A method of training a machine learning model for classification is described. Training data elements to be classified and rules for classification are received. A first content payload, configured to be served by a content delivery system, is generated. The first content payload represents a first training data element and corresponding rules for classification. The first content payload is sent to the content delivery system for classification of the first training data element by users of a plurality of user devices. Classification samples are received for the first training data element based on the first content payload. Classification identifiers that indicate selected classes for the first training data element are generated based on the classification samples. A machine learning model is trained to classify wild data elements according to the rules for classification using the classification identifiers and the first training data element.

### BACKGROUND

Machine learning provides many improvements in computer processing, such as image classification, voice recognition, and even image generation. However, the sourcing of high-quality training datasets is often laborious, with challenges in both collection of data and classification of that data. For example, training a machine learning model or machine learning model to classify images of dogs according to their breed would typically require creation of a data set of images that are initially unlabeled, but are then labeled to be correctly classified (i.e., labeled with a dog breed, such as dachshund or bulldog). Acquiring a suitable data set for training using less common subjects or areas where specialized knowledge is required to provide an accurate classification is often expensive and/or time consuming.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to training a machine learning model.

In one aspect, a computer-implemented method of training a machine learning model for classification is provided. The method includes: receiving, by a training data processor, training data elements to be classified and rules for classification of the training data elements; generating, by the training data processor, a first content payload that is configured to be served by a content delivery system to a plurality of user devices, wherein the first content payload represents at least a first training data element and corresponding rules for classification of the first training data element; sending, by the training data processor, the first content payload to the content delivery system for display by the plurality of user devices and classification of the first training data element by users of the plurality of user devices; receiving, by a classification processor from the content delivery system, classification samples for the first training data element based on the first content payload; generating, by the classification processor, classification identifiers that indicate selected classes for the first training data element based on the classification samples; and training, by a training processor, a machine learning model to classify wild data elements according to the rules for classification using the classification identifiers and the first training data element.

In another aspect, a computer-implemented method of training a machine learning model is provided. The method includes: receiving, from a training data processor, a content payload package having a plurality of content payloads and respective user device selection criteria, the plurality of content payloads comprising a first content payload representing a first training data element to be classified and rules for classification of the first training data element; identifying, for the first content payload, first targeted devices that satisfy first user device selection criteria corresponding to the first content payload; receiving a request for content from a first user device of the first targeted devices; sending the first content payload to the first user device in response to the request, wherein the first content payload causes the first user device to render the training data element of the first content payload and a human-readable representation of the rules for classification of the first training data element on the first user device; receiving a first classification sample from the first user device for the first training data element based on the first content payload, wherein the first classification sample represents training data for a machine learning model; sending the first classification sample to the training data processor for training of the machine learning model.

In yet another aspect, a system for training a machine learning model for classification is provided. The system includes a training data processor, a classification processor, and a training processor. The training data processor training data processor configured to: receive training data elements to be classified and rules for classification of the training data elements; generate a first content payload that is configured to be served by a content delivery system to a plurality of user devices, wherein the first content payload represents at least a first training data element and corresponding rules for classification of the first training data element; and send the first content payload to the content delivery system for display by the plurality of user devices and classification of the first training data element by users of the plurality of user devices. The classification processor configured to: receive, from the content delivery system, classification samples for the first training data element based on the first content payload; and generate classification identifiers that indicate selected classes for the first training data element based on the classification samples. The training processor configured to: training a machine learning model to classify wild data elements according to the rules for classification using the classification identifiers and the first training data element.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example of a system for training a machine learning model, according to an example embodiment.

FIG. 2 shows a block diagram of an example of a training data processor that generates a content payload package, according to an example embodiment.

FIG. 3A and FIG. 3B show diagrams of an example user interface for receiving classification samples, according to an example embodiment.

FIG. 4 shows a flowchart of an example method of training a machine learning model, according to an example embodiment.

FIG. 5 shows a flowchart of an example method of training a machine learning model, according to another example embodiment.

FIG. 6 is a block diagram illustrating example physical components of a computing device with which aspects of the disclosure may be practiced.

FIGS. 7 and 8 are simplified block diagrams of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various examples of related to generating a training set of data for training a machine learning model. To simplify creation of a suitable set of training data, a training data processor creates a content payload having training data elements (e.g., images, audio) and rules for classification of the training data elements. For example, the rules could indicate that a user should select which training data elements contain a dog of a certain breed. The content payload is configured to be distributed among a large group of user devices that present the training data elements and rules to corresponding users via a user interface. The users may interact with the user interface to provide a classification sample for the training data element, where the classification sample indicates a selection of a classification from a particular user.

More specifically, the content payload is configured to be distributed using an existing content delivery system, such as a news feed, website content network, streaming service, or other suitable content delivery system. In some examples, the content delivery system is configured for targeted delivery of content to users based on user profiles, such as browsing history, purchase history, or location history. The training data processor may provide selection criteria for targeting specific users or groups of users to improve classification accuracy of the training data elements. For example, users with a search history related to dogs may be targeted for classification of images of dogs. In some examples, the content delivery system provides a reward to the users for participation in the classification.

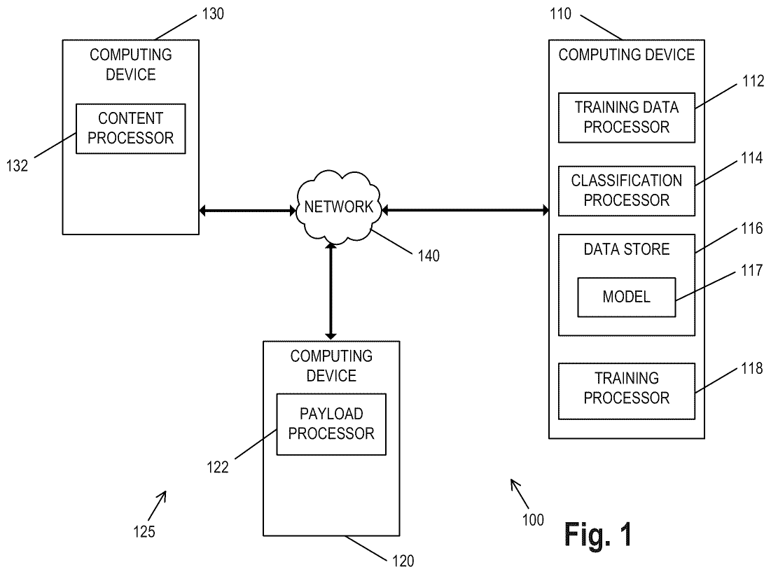

This and many further aspects for a computing device are described herein. For instance, FIG. 1 shows a block diagram of an example of a system 100 for training a machine learning model, according to an example aspect. As shown in FIG. 1, the system 100 includes a computing device 110, a computing device 120, and a computing device 130. A network 140 communicatively couples the computing devices 110, 120, and 130.

Computing device 110 may be any type of computing device, including a mobile computer or mobile computing device (e.g., a Microsoft® Surface® device, a laptop computer, a notebook computer, a tablet computer such as an Apple iPad™, a netbook, etc.), or a stationary computing device such as a desktop computer or PC (personal computer). In some aspects, computing device 110 is a cable set-top box, streaming video box, or console gaming device. In other aspects, the computing device 110 is a cloud computing device or network server. Computing device 110 may be configured to execute one or more software applications (or “applications”) and/or services and/or manage hardware resources (e.g., processors, memory, etc.), which may be utilized by users of the computing device 110.

Computing device 120 and computing device 130 are members of a content delivery system 125. Generally, the computing device 120 is a network server or cloud computing device, while the computing device 130 is a client computing device, such as a smartphone, mobile computing device, or stationary computing device. However, in other examples, either of the computing device 120 or 130 may be implemented as any suitable type of computing device. Computing devices 120 and 130 may be configured to execute one or more software applications (or “applications”) and/or services and/or manage hardware resources (e.g., processors, memory, etc.), which may be utilized by users of the computing device 110.

In some examples, the content delivery system 125 provides a website or other accessible storage with content, such as blog posts, images, chat messages or topics, news, articles, publications, videos, etc. For example, the computing device 120 hosts a service that provides content or content payloads to users of the computing device 130. The computing device 120 includes a payload processor 122 that selects content payloads to be distributed to different computing devices 130. The payload processor 122 provides an interface for sending content payloads to the computing device 130, such as an application programming interface or other suitable communication channel. In some examples, the payload processor 122 is configured to handle content payload having a preselected format or data structure.

The computing device 130 includes a content processor 132 that is configured to present the content payload to a user of the computing device 130. In some examples, the content processor 132 utilizes a web browser, an app (e.g., a game or other app), an application programming interface, or other suitable executable code to retrieve and/or present the content payload. The content processor 132 is configured to request a content payload from the computing device 120. For example, an application executed by the content processor 132 causes the computing device 130 to send a request to the computing device 120 using an application programming interface (API), hypertext transfer protocol (HTTP) request, or other suitable request. In some examples, the content processor 132 is configured to display the content payload in line with, or otherwise associated with, other content, such as a news article, web page, news feed, a video, or other suitable content. In these examples, the user is not required to interact with the content payload and may, in some scenarios, ignore or disregard the content payload.

In various examples, the content processor 132 displays images or text on a display or plays audio on speakers coupled with the computing device 130 to present the content payload to the user. In some examples, the content delivery system 125 implements an advertisement distribution system. For example, the payload processor 122 is configured to provide the content payloads to the computing devices 130 as content embedded within other content, such as a game application, news application, a video, a webpage, a web browser application, etc. In some such examples, the content payloads are generated with a suitable format (e.g., HTML, XML, JavaScript) or data structure that is processable by the content processor 132.

The computing device 110 comprises a training data processor 112, a classification processor 114, a data store 116, and a training processor 118. The training data processor 112 is configured to receive training data elements to be classified and rules for classification of the training data elements. As described above, the training data elements may be images, audio, video, text, or content in any other type of format, to be classified or otherwise labeled in a manner suitable for training a machine learning model. The rules generally indicate how a user should classify the training data element, for example, by instructing the user to select training data elements of images having a dog of a certain breed, or to enter text describing dog breeds within an image, etc. In various examples, the training data processor 112 receives the training data elements from a published data set of images or audio, a web crawl of the Internet, or from a selection provided by a user. In one such example, a researcher desiring to train a machine learning model for a particular task may select content and/or other training data elements that, once labeled, would facilitate training the machine learning model.

The training data processor 112 is further configured to generate content payloads that may be served by the content delivery system 125 to a plurality of user devices (e.g., the computing device 130). For example, the training data processor 112 may generate a first content payload that represents at least a first training data element (e.g., images of animals) and corresponding rules for their classification (e.g., “Select the images with dogs”, “Is there a car in this image?”, “what colors are the cars in this image?”) or segmentation. The training data processor 112 is configured to send the content payload to the content delivery system 125 for presentation by the computing device 130 and classification of the training data elements by users of the computing devices 130.

The rules may indicate a format of a response elicited from the user, such as radio buttons (e.g., yes/no answers), checkboxes, sliders (e.g., rank a feature in an image between 1-5), text input, image or file uploads (e.g., to capture user-provided inputs that satisfy the rules, such as pictures of the user's dog of a certain breed), or other suitable user interface widgets. In some examples, the rules are provided within the content payload as a script that causes a user interface widget on the computing device 130 to be provided to the user. Accordingly, execution of the script may cause the content processor 132 to render the training data elements and a human-readable representation of the rules for classification on a display (not shown) of the computing device 130. Generally, the response is referred to herein as a classification sample and may be provided as an integer (e.g., indicating an entry selected from a list), text (e.g., entered by a user), data uploaded by the user, or other suitable formats.

In various examples, the training data elements could be actual data, links to data, or executable code that determines a link to the data. Examples of the data include images, videos, text, audio sample, files, or other suitable data formats. A content payload may include one, two, three, or more training data elements. However, in some examples, the training data elements are not directly provided and instead, the user of the computing device 130 selects or uploads the training data element (or a link to the training data element, such as an Internet URL). For example, the rules may instruct a user to upload or capture an image of their dog wearing a hat.

The training data processor 112 may be configured to process the training data elements, in some scenarios. For example, when high quality images or audio are provided, the training data processor 112 may crop, compress, reduce image/audio quality, or perform other suitable processing to reduce a file size of the training data elements, improve readability (e.g., changing text color, font, or size), sensor or blur personally identifiable material, etc.

In some examples, the training data processor 112 generates a content payload for a particular user, group of users, or user devices that satisfy user device selection criteria. In one example, the content payload includes an indication of the user device selection criteria. In another example, the content payload is provided to the computing device 120 with a separate indication of the user device selection criteria. In various examples, the user device selection criteria specify characteristics of the user devices to which the content payload should be provided, such as an operating system (Android, iOS, etc.), camera quality (e.g., 12 megapixels, 20+ megapixels), installed applications or security updates, or other suitable criteria.

In other examples, the user device selection criteria specify characteristics of the users themselves, such as browsing history, purchase history, location history, application use history, etc. In one example, a user that has a search history or other familiarity with dogs (or other profile information suggesting a higher than average level of experience or expertise in a subject matter) may be targeted for a content payload related to identifying dog breeds within images. In another example, a user with a location history at music venues may be targeted for a content payload related to identifying musical features in an audio file. In still other examples, users with a particular profile may be de-prioritized for targeting of a content payload, for example, to reduce a perceived bias for classification or exclude individuals without suitable familiarity with a particular subject matter. In some examples, users themselves are anonymous with respect to the computing device 110. In other words, the users are not personally identifiable. For example, the users may be identified by a unique, but anonymous or pseudo-anonymous identifier (e.g., a unique ID, or advertiser identifier)

For participation in the classification of the training data elements, a reward may be provided to the computing device 130 or its user. In some examples, the reward is an electronic gift card, a digital asset (e.g., an item or aesthetic outfit for use within a game), a non-fungible token (NFT). In other examples, the reward is allowing the user to continue using a game or other application or to continue receiving updates from a news feed or blog. A link or identifier for the reward may be included in the content payload, in some examples. In other examples, the content delivery system 125 is configured to provide the reward (e.g., through continued access to a game).

The classification processor 114 is configured to receive classification samples from the computing device 130. Since there may be an element of error or inaccuracy in some classification samples, the classification processor 114 may be configured to process the classification samples validate the classification samples, to filter out undesirable classification samples, or other suitable processing. In some scenarios, a particular training data element may be ambiguous or confusing to some users, resulting in a less decisive classification. For example, an image of a young leopard may appear similar to an image of a young cheetah to some users and result in incorrect classification (e.g., “Is this a leopard or cheetah?”) of an image of a leopard. The classification processor 114 may filter out training data elements where accuracy levels or confidence levels do not meet a preselected threshold (e.g., discard a training data element if confidence is less than 75%). In other examples, the classification processor 114 may filter out classification samples from users that do not meet a previously determined accuracy level for prior content payloads. In other words, when a user is typically inaccurate when classifying images of birds, classification samples from that user related to birds may be discarded, or weighted to reduce their impact, etc. In other examples, some users may have their classification samples weighted or prioritized, for example, when they have a prior history of accuracy or knowledge.

The classification processor 114 generates classification identifiers that indicate selected classes for the training data elements based on the classification samples received from the computing devices 130. For example, the classification processor 114 may aggregate the classification samples and select a single classification for a particular training data element (e.g., indicating that an image contains a dachshund, etc.). In other examples, the classification processor 114 may generate classification identifiers for multiple classes (e.g., a top two identifiers, top five identifiers, etc.). The classification processor 114 may then label the training data elements with the classification identifiers for training of a machine learning model. In some examples, the classification processor 114 generates a training package with the labeled training data elements.

In some examples, the classification processor 114 provides feedback to the training data processor 112 for content payloads to be generated. For example, the training data processor 112 may generate a second content payload with a same training data element as a first content payload, but with different user device selection criteria based on classification samples received for the first content payload. This approach may improve accuracy of labeling a training data element by targeting content payload to users with more familiarity of a subject. In other examples, the training data processor 112 generates the second content payload using different rules or a different set of training data elements based on the feedback.

The data store 116 is configured to store data, for example, a machine learning model 117 (or neural network model). The data store 116 may also store one or more of the training data elements, rules, classification samples, content payload packages, or training packages. In various embodiments, the data store 116 is a network server, cloud server, network attached storage (“NAS”) device, or other suitable computing device. Data store 116 may include one or more of any type of storage mechanism, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data store 116 is shown in FIG. 1, the system 100 may include two, three, or more similar instances of the data store 116. Moreover, the network 140 may provide access to other data stores, similar to data store 116 that are located outside of the data graph processing system 100, in some embodiments.

The training processor 118 is configured to train the machine learning model 117 using the training package from the classification processor 114. Generally, the machine learning model 117 is trained to classify wild data elements (e.g., unlabeled images) based on the labeled training data elements from the training package. In some examples, the machine learning model 117 is trained to generate new data, such as generating a new image based on a text description (e.g., “two pit bulls wearing pajamas”). Other suitable purposes for which the machine learning model 117 can be trained will be apparent to those skilled in the art.

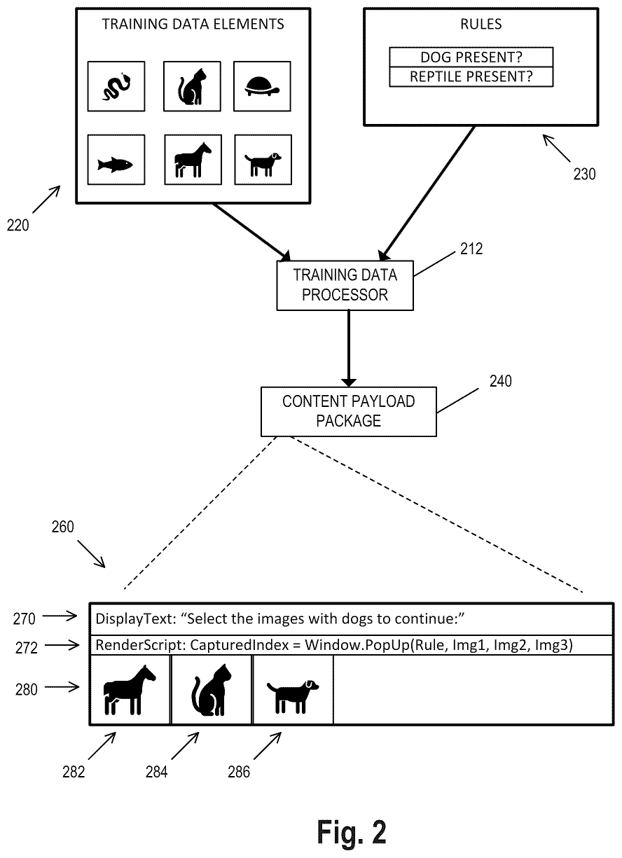

FIG. 2 shows a block diagram of an example of a training data processor 212 that generates a content payload package 240, according to an example embodiment. The training data processor 212 generally corresponds to the training data processor 112. The training data processor 212 receives training data elements from a training data element store 220 and one or more rules from a rule store 230. In some examples, the training data element store 220 and the rule store 230 are filled by a researcher or user intending to train a machine learning model.

In the example shown in FIG. 2, the training data element store 220 includes six images of a snake, cat, turtle, fish, horse, and dog and the rules store 230 includes two rules corresponding to whether a dog is present or a reptile is present. The training data processor 212 generates a content package 240 having a plurality of content payloads, such as content payload 260. Combining multiple content payloads may improve delivery efficiency to the computing device 120 and/or to the computing device 130. The content payload 260 has a structure consistent with a structure supported by the payload processor 122. In the example shown in FIG. 2, the content payload 260 includes a display text 270, a rendering script 272, and a plurality of training data elements (images 282, 284, and 286). Other content payloads within the content payload package 240 may have same or different display text, rendering scripts, and/or training data elements. In some examples, other content payloads within the content payload package have the same display text 270 and rendering script 272, but some variation in the training data elements 280, such as a different ordering of the training data elements 280, or different training data elements (e.g., substituting the fish image for the cat image). The training data processor 212 may be configured to randomize the content payloads within the content payload package 240 to improve statistical diversity for the classification samples (e.g., avoiding errors or common answers based on biased images or instructions). In other examples, the training data processor 212 generates the render script 272 to be different among different content payloads to move locations of user interface buttons or widgets. In this way, bias towards interacting with a more convenient widget instead of an accurate widget may be promoted. In other words, variations in the training data elements, display text, or render script may be introduced into the content payloads to avoid bias created by users that ignore the rules and attempt to simply “click through” to more quickly receive a reward.

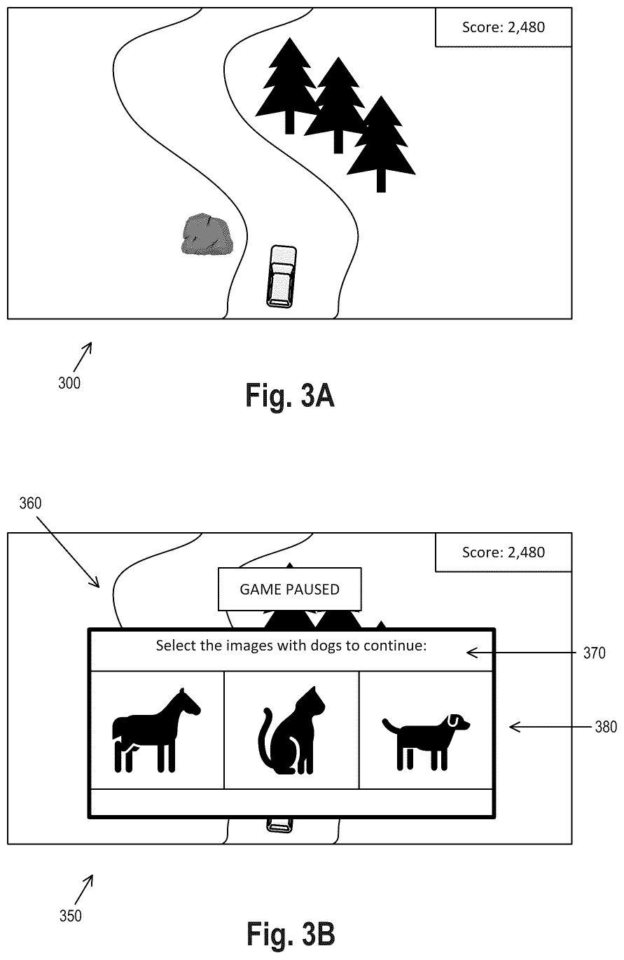

FIG. 3A and FIG. 3B show diagrams of an example user interface for receiving classification samples, according to an example embodiment. In FIG. 3A, a user interface 300 is displayed by the content processor 132. In the example of FIG. 3A, the user interface 300 corresponds to a driving game that a user may play on the smartphone or personal computer (i.e., computing device 130). The driving game may be configured to use an application programming interface provided by the content delivery system 125 to request content from the computing device 120. In some examples, the driving game may request a content payload at predetermined time intervals, such as every three minutes, five minutes, etc.

In the example of FIG. 3B, a user interface 350 is displayed by the content processor 132 after receiving the content payload 260 via the application programming interface. The user interface 350 includes a pop-up window 360 having a first area with rules or instructions 370 for classifying images and a second area for a plurality of training data elements 380 (generally corresponding to training data elements 280). A user of the computing device 110 may interact with the second area (e.g., by clicking on the training data elements) to select an image of a dog, in accordance with the instructions 370.

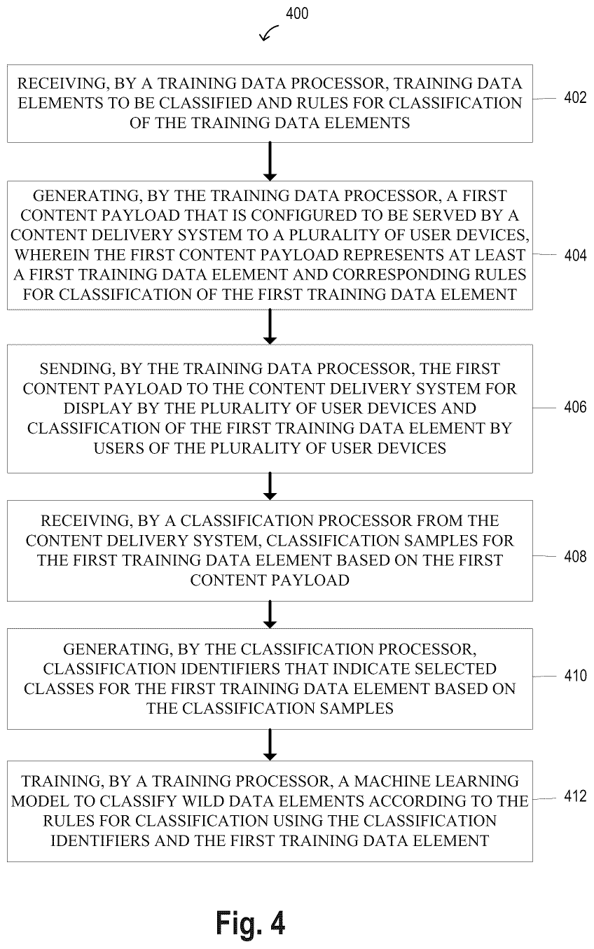

FIG. 4 shows a flowchart of an example method 400 of training a machine learning model, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 4. Steps may be performed serially, in a partially overlapping manner, or fully in parallel. Thus, the order in which steps of method 400 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 4 may be performed by the computing device 110 (e.g., via the training data processor 112, the classification processor 114, the training processor 118), the computing device 120 (e.g., via the payload processor 122), the computing device 130 (e.g., via the content processor 132), or other suitable computing device.

Method 400 begins with step 402. At step 402, training data elements to be classified and rules for classification of the training data elements are received by a training data processor, such as the training data processor 112.

At step 404, a first content payload that is configured to be served by a content delivery system to a plurality of user devices is generated by the training data processor. The first content payload represents at least a first training data element and corresponding rules for classification of the first training data element. In one example, the first content payload corresponds to the content payload 260.

At step 406, the first content payload is sent to the content delivery system for display by the plurality of user devices and classification of the first training data element by users of the plurality of user devices. The content delivery system generally corresponds to the content delivery system 125, in one example.

At step 408, classification samples for the first training data element based on the first content payload are received by a classification processor from the content delivery system. The classification processor generally corresponds to the classification processor 114, in some examples.

At step 410, classification identifiers that indicate selected classes for the first training data element are generated based on the classification samples.

At step 412, a machine learning model is trained to classify wild data elements according to the rules for classification using the classification identifiers and the first training data element. The machine learning model generally corresponds to the machine learning model 117 and is trained by the training processor 118, for example.

In some aspects, the first content payload includes first executable code that configures the plurality of user devices to provide the classification samples to the classification processor via the content delivery system.

In some aspects, the first content payload further includes second executable code that configures the plurality of user devices to render at least some of the training data elements and a human-readable representation of the rules for classification by the users of the plurality of user devices.

In some aspects, generating the classification identifiers comprises discarding at least some of the classification samples that do not meet a predetermined confidence threshold.

In some aspects, the method 400 further comprises sending user device selection criteria for the first content payload to the content delivery system, wherein the user device selection criteria causes the content delivery system to select the plurality of user devices from among available user devices that satisfy the user device selection criteria for the first content payload.

In some aspects, the user device selection criteria comprise one or more of browsing history, purchase history, or location history of the available user devices.

In some aspects, the user device selection criteria comprise prior accuracy of the available user devices for classification of prior content payloads.

In some aspects, the method 400 further comprises generating, by the classification processor, a content package having a plurality of content payloads, including the first content payload, and sending user device selection criteria for the plurality of content payloads to the content delivery system, wherein the user device selection criteria for the plurality of content payloads causes the content delivery system to select a respective plurality of user devices from among the available user devices that satisfy the user device selection criteria for each of the plurality of content payloads.

In some aspects, each of the plurality of content payloads has a corresponding user device selection criteria.

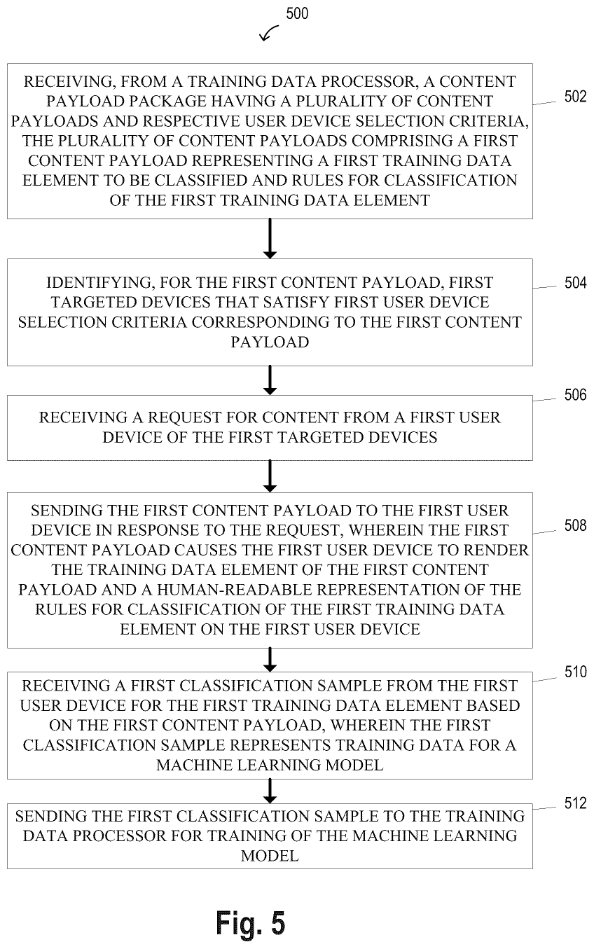

FIG. 5 shows a flowchart of an example method 500 of training a machine learning model, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the computing device 110 (e.g., via the training data processor 112, the classification processor 114, the training processor 118), the computing device 120 (e.g., via the payload processor 122), the computing device 130 (e.g., via the content processor 132), or other suitable computing device.

Method 500 begins with step 502. At step 502, a content payload package having a plurality of content payloads and respective user device selection criteria is received from a training data processor. The plurality of content payloads comprising a first content payload representing a first training data element to be classified and rules for classification of the first training data element. The training data processor generally corresponds to the training data processor 112, in some examples.

At step 504, first targeted devices that satisfy first user device selection criteria corresponding to the first content payload are identified for the first content payload.

At step 506, a request for content is received from a first user device of the first targeted devices.

At step 508, the first content payload is sent to the first user device in response to the request, wherein the first content payload causes the first user device to render the training data element of the first content payload and a human-readable representation of the rules for classification of the first training data element on the first user device.

At step 510, a first classification sample is received from the first user device for the first training data element based on the first content payload, wherein the first classification sample represents training data for a machine learning model.

At step 512, the first classification sample is sent to the training data processor for training of the machine learning model.

In some aspects, identifying the first targeted devices comprises identifying the first targeted devices from among a plurality of available user devices based on one or more of browsing history, purchase history, or location history of the available user devices.

In some aspects, the plurality of content payloads comprises a second content payload representing a second training data element to be classified and rules for classification of the second training data element. In some aspects, the method 500 further comprises: identifying, for the second content payload, second targeted devices that satisfy second user device selection criteria corresponding to the second content payload; receiving a request for content from a second user device of the second targeted devices; sending the second content payload to the second user device in response to the request, wherein the first content payload causes the second user device to render the training data element of the second content payload and a human-readable representation of the rules for classification of the second training data element on the second user device; receiving a second classification sample from the second user device for the second training data element based on the second content payload, wherein the second classification sample represents further training data for the machine learning model; sending the second classification sample to the training data processor for training of the machine learning model.

In some aspects, the second user device selection criteria are distinct from the first user device selection criteria.

In some aspects, the method 500 further comprises providing an application programming interface (API) through which the request is received, the first content payload is sent, and the first classification sample is received.

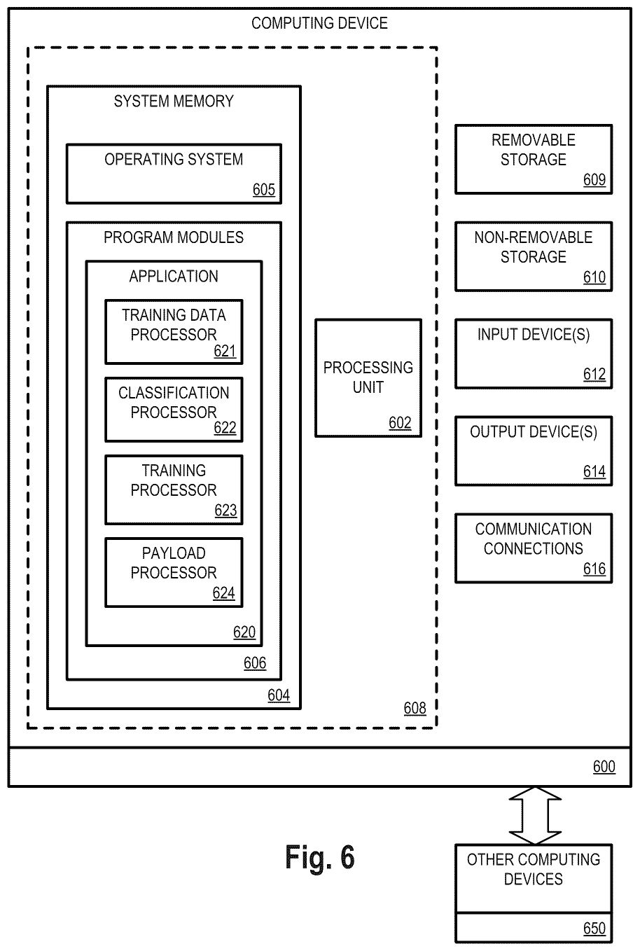

FIG. 6 is a block diagram illustrating physical components (e.g., hardware) of a computing device 600 with which aspects of the disclosure may be practiced. The computing device components described below may have computer executable instructions for implementing a machine learning training application 620 on a computing device (e.g., computing device 110, 120, or 130), including computer executable instructions for machine learning training application 620 that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running machine learning training application 620, such as one or more components with regard to FIGS. 1, 2, 3A, and 3B and, in particular, training data processor 621 (e.g., corresponding to training data processor 112), classification processor 622 (e.g., corresponding to classification processor 114), training processor 623 (e.g., corresponding to training processor 118), and payload processor 624 (e.g., corresponding to payload processor 122).

The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., machine learning training application 620) may perform processes including, but not limited to, the aspects, as described herein. Other program modules that may be used in accordance with aspects of the present disclosure, and in particular for training a machine learning model, may include training data processor 621, classification processor 622, training processor 623, or payload processor 624.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

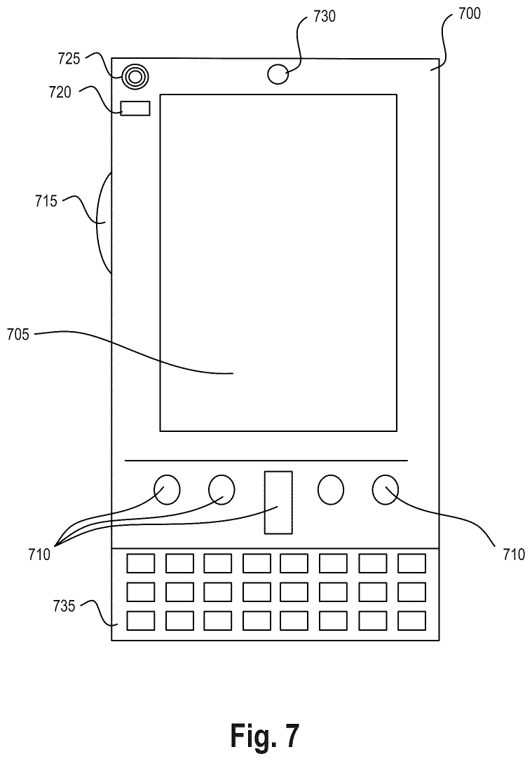

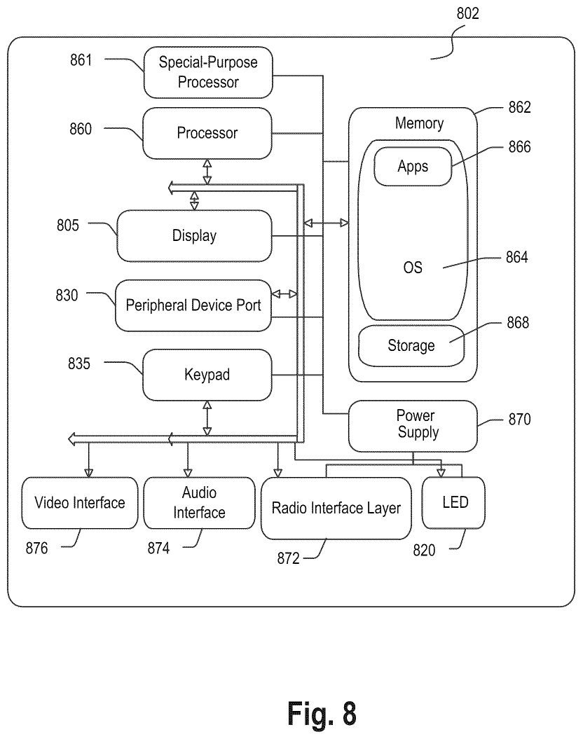

FIGS. 7 and 8 illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 8 is a block diagram illustrating the architecture of one aspect of a mobile computing device. That is, the mobile computing device 700 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 725 (e.g., audio transducer 725 illustrated in FIG. 7). In the illustrated embodiment, the visual indicator 820 is a light emitting diode (LED) and the audio transducer 725 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 725, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like.

A mobile computing device 700 implementing the system 802 may have additional features or functionality. For example, the mobile computing device 700 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 700 and stored via the system 802 may be stored locally on the mobile computing device 700, as described above, or the data may be stored on any number of storage media that may be accessed by the device via the radio interface layer 872 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 7 and 8 are described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method of training a machine learning model for classification, the computer-implemented method comprising:
receiving, by a training data processor, training data elements to be classified and rules for classification of the training data elements;
generating, by the training data processor, a first content payload that is configured to be served by a content delivery system to a plurality of user devices, wherein the first content payload represents at least a first training data element and corresponding rules for classification of the first training data element;
sending, by the training data processor, the first content payload to the content delivery system for display by the plurality of user devices and classification of the first training data element by users of the plurality of user devices;
receiving, by a classification processor from the content delivery system, classification samples for the first training data element based on the first content payload;
generating, by the classification processor, classification identifiers that indicate selected classes for the first training data element based on the classification samples; and
training, by a training processor, a machine learning model to classify wild data elements according to the rules for classification using the classification identifiers and the first training data element.

2. The computer-implemented method of claim 1, wherein the first content payload includes first executable code that configures the plurality of user devices to provide the classification samples to the classification processor via the content delivery system.

3. The computer-implemented method of claim 2, wherein the first content payload further includes second executable code that configures the plurality of user devices to render at least some of the training data elements and a human-readable representation of the rules for classification by the users of the plurality of user devices.

4. The computer-implemented method of claim 3, wherein generating the classification identifiers comprises discarding at least some of the classification samples that do not meet a predetermined confidence threshold.

5. The computer-implemented method of claim 3, wherein the method further comprises:
sending user device selection criteria for the first content payload to the content delivery system, wherein the user device selection criteria causes the content delivery system to select the plurality of user devices from among available user devices that satisfy the user device selection criteria for the first content payload.

6. The computer-implemented method of claim 5, wherein the user device selection criteria comprise one or more of browsing history, purchase history, or location history of the available user devices.

7. The computer-implemented method of claim 5, wherein the user device selection criteria comprise prior accuracy of the available user devices for classification of prior content payloads.

8. The computer-implemented method of claim 5, the method further comprising:
generating, by the classification processor, a content package having a plurality of content payloads, including the first content payload;
sending user device selection criteria for the plurality of content payloads to the content delivery system, wherein the user device selection criteria for the plurality of content payloads causes the content delivery system to select a respective plurality of user devices from among the available user devices that satisfy the user device selection criteria for each of the plurality of content payloads.

9. The computer-implemented method of claim 8, wherein each of the plurality of content payloads has a corresponding user device selection criteria.

10. A computer-implemented method of training a machine learning model, the computer-implemented method comprising:
receiving, from a training data processor, a content payload package having a plurality of content payloads and respective user device selection criteria, the plurality of content payloads comprising a first content payload representing a first training data element to be classified and rules for classification of the first training data element;
identifying, for the first content payload, first targeted devices that satisfy first user device selection criteria corresponding to the first content payload;
receiving a request for content from a first user device of the first targeted devices;
sending the first content payload to the first user device in response to the request, wherein the first content payload causes the first user device to render the training data element of the first content payload and a human-readable representation of the rules for classification of the first training data element on the first user device;
receiving a first classification sample from the first user device for the first training data element based on the first content payload, wherein the first classification sample represents training data for a machine learning model;
sending the first classification sample to the training data processor for training of the machine learning model.

11. The computer-implemented method of claim 10, wherein identifying the first targeted devices comprises identifying the first targeted devices from among a plurality of available user devices based on one or more of browsing history, purchase history, or location history of the available user devices.

12. The computer-implemented method of claim 10, wherein the plurality of content payloads comprises a second content payload representing a second training data element to be classified and rules for classification of the second training data element;
wherein the method further comprises:
identifying, for the second content payload, second targeted devices that satisfy second user device selection criteria corresponding to the second content payload;
receiving a request for content from a second user device of the second targeted devices;
sending the second content payload to the second user device in response to the request, wherein the first content payload causes the second user device to render the training data element of the second content payload and a human-readable representation of the rules for classification of the second training data element on the second user device;
receiving a second classification sample from the second user device for the second training data element based on the second content payload, wherein the second classification sample represents further training data for the machine learning model;
sending the second classification sample to the training data processor for training of the machine learning model.

13. The computer-implemented method of claim 12, wherein the second user device selection criteria are distinct from the first user device selection criteria.

14. The computer-implemented method of claim 10, wherein the method further comprises providing an application programming interface (API) through which the request is received, the first content payload is sent, and the first classification sample is received.

15. A system for training a machine learning model for classification, the system comprising:
a training data processor configured to:
receive training data elements to be classified and rules for classification of the training data elements;
generate a first content payload that is configured to be served by a content delivery system to a plurality of user devices, wherein the first content payload represents at least a first training data element and corresponding rules for classification of the first training data element; and
send the first content payload to the content delivery system for display by the plurality of user devices and classification of the first training data element by users of the plurality of user devices;
a classification processor configured to:
receive, from the content delivery system, classification samples for the first training data element based on the first content payload; and
generate classification identifiers that indicate selected classes for the first training data element based on the classification samples;
a training processor configured to:
training a machine learning model to classify wild data elements according to the rules for classification using the classification identifiers and the first training data element.

16. The system of claim 15, wherein the first content payload includes:
first executable code that configures the plurality of user devices to provide the classification samples to the classification processor via the content delivery system; and
second executable code that configures the plurality of user devices to render at least some of the training data elements and a human-readable representation of the rules for classification by the users of the plurality of user devices.

17. The system of claim 16, wherein the training data processor is configured to send user device selection criteria for the first content payload to the content delivery system, wherein the user device selection criteria causes the content delivery system to select the plurality of user devices from among available user devices that satisfy the user device selection criteria for the first content payload.

18. The system of claim 17, wherein the user device selection criteria comprise one or more of browsing history, purchase history, or location history of the available user devices.

19. The system of claim 17, wherein the user device selection criteria comprise prior accuracy of the available user devices for classification of prior content payloads.

20. The system of claim 17, wherein the classification processor is configured to generate a content package having a plurality of content payloads, including the first content payload;
wherein the training data processor is configured to send user device selection criteria for the plurality of content payloads to the content delivery system, wherein the user device selection criteria for the plurality of content payloads causes the content delivery system to select a respective plurality of user devices from among the available user devices that satisfy the user device selection criteria for each of the plurality of content payloads.
